(19) United States
(12) Patent Application Publication
(10) Pub. No.: US 2026/0208778 A1
(43) Pub. Date: Jul. 23, 2026

(54) TRANSFORMABLE CART

(71) Applicant: S.A.T.P, Cholet (FR)

(72) Inventor: Jean-Pierre MONTIGNY, Cholet (FR)

(21) Appl. No.: 19/028,961

(22) Filed: Jan. 17, 2025

(51) Int. Cl. B62B 1/12; A47C 1/14; A47C 13/00

(52) U.S. Cl. CPC B62B 1/12; A47C 1/14; A47C 13/00; B62B 2206/006

(57) ABSTRACT

The invention relates to a transformable shopping cart capable of going from its strictly speaking “shopping cart” position to one of the following positions: “handcart”; “seat”; “deck chair”; and “bench”, comprising a framework mounted on at least one wheel, wherein the framework is made of four parts, namely: a so-called central framework, a so-called first end framework, a so-called second end framework and a so-called support part.

This invention relates to a transformable shopping cart capable of going from its strictly speaking “shopping cart” position to one of the following positions: “handcart”; “seat”; “deck chair” and “bench”.

Known from document FR 3021853 A1 is a transformable modular assembly that can adopt several positions, such as deck chair, chair cart and transport cart positions.

These transformable devices are most often used on the beach where the presence of sand can be a problem for the mechanical articulations of such transformable devices. In particular, the use of slides can be made difficult by the presence of sand.

Such devices must also be extremely simple to operate and have a minimum number of parts to make up the cart.

For example, in order to be presented in its cart version, the device presented in document FR 3021853 A1 has supernumerary panels to form the sides of the cart, these panels being placed in U-shaped profiles forming slides.

The use of these supernumerary panels increases the weight of the cart and increases its manufacturing cost in order to constitute the cart position of this transformable device. In addition, the use of slides makes it more difficult to use such a cart, for example on a beach, as sand can get into the slides and make it more difficult to arrange the supernumerary panels.

To this end, the present invention relates to a transformable shopping cart capable of going from its strictly speaking “shopping cart” position to one of the following positions:
“handcart”;
“seat”;
“deck chair”; and
“bench”, comprising a framework mounted on at least one wheel, wherein the framework is made of four parts, namely:
a so-called central framework A formed by two identical parallel lateral arms that each comprise a central part extended at a first end by a first fold and at the other end by a second fold on the same side as the first fold, the central parts of these two arms being joined by at least one strip of material;
on the side of the first folds of the central part, a so-called first end framework B formed by two identical parallel lateral arms that each comprise a central part extended at a first end by a first fold and at the other end by a second fold on the same side as the first fold, the central parts of these two arms being joined by at least one strip of material; each second fold of the first end framework B being mounted movable in rotation on each first fold of the central framework A;
on the side of the second folds of the central framework A, a so-called second end framework C formed by two identical parallel lateral arms joined by at least one strip of material, mounted able to pivot by one of their ends at a point of the corresponding lateral arm of the central framework A that is located in the vicinity of the start of the second fold of the latter;
a so-called support part D comprising two lateral edges each articulated to the corresponding end of the second folds of the lateral arms of the central framework A, and a transverse end edge capable of blocking the second end framework C in an inclined position relative to the central framework A; said wheel(s) being carried by at least one lateral arm of the central framework A in its second fold part, the axle of the wheel(s) being perpendicular to the lateral arms of the central framework A;
the “shopping cart” position being obtained by applying the central framework A and the second end framework C against one another, a removable blocking device of these two frameworks being provided, and by pressing the first two folds of the first end framework B against the respective second folds of the central framework A; and the support part D being, in the fully raised position, a removable blocking device provided to maintain the first end framework B in this position against the central framework A and at least one removable blocking device being provided to maintain the support part D in its raised position;
the “handcart” position differing from the “shopping cart” position in that the support part D is folded down, a removable blocking device being provided to maintain the first end framework B against the central framework A;
the “seat” position differing from the “shopping cart” position in that the second end framework C is inclined relative to the central framework A, and in that the support part D blocks the second end framework C in its inclined position;
the “deck chair” position differing from the seat position in that the first end framework B is placed in the extension of the central framework A;
the “bench” position differing from the “deck chair” position in that the support part D is in its position applied against the central framework A and in that the second end framework C comes in the extension of the central framework A.

The folds of the second end framework (C) as well as the folds of the central framework (A) form the edges and sides of the cart in its “shopping cart” and “handcart” positions, thus avoiding the need to use supernumerary parts to form them.

The first two folds of the central framework A can be connected to form a U-shaped part.

The base of the U which connects the first two folds of the central framework A can carry a device for hooking the cart to a means of locomotion, such as a bicycle.

The first two folds of the first end framework B can be connected to form a U, which advantageously carries the removable hooking device for hooking to the support part.

The two lateral arms of the second end framework C can be joined at their edges opposite their point of articulation to the central framework A, to advantageously form a pull handle in the “shopping cart” position or a push handle in the “handcart” position.

The removable hooking device for hooking the central framework A to the second end framework C can be carried by at least one lateral arm of the central framework A for hooking to the corresponding lateral arm of the second end framework C.

The removable hooking device for hooking the central framework A to the first end framework B can be carried by a lateral arm of the central framework A for hooking to the corresponding first fold of the first end framework B or, when it is provided, to the connection between the first folds of the first end framework B.

According to a first variant, at least on one side, a connection having an articulation in its middle part can be connected on the one hand to a lateral edge of the support part D and on the other hand to the second fold of the corresponding lateral arm of the central framework A.

According to a second variant, at least on one side, preferably on both sides, the corresponding edge of the support part D is extended beyond the articulation pin by an arm folded inwards, so that, when placed in the “handcart” position, said folded arm abuts against the corresponding lateral arm of the central framework A.

The frameworks A, B and C and the support part D can each be made of a bent profile to form the necessary folds.

These profiles can have any cross-section. For example, they may be profiles with an L-shaped, U-shaped or other cross-section. Advantageously, the profiles can be tubes of any cross-section, such as round, oval or square cross-sections.

The second folds of the central framework A can form a V flared upwards in the “seat” or “deck chair” or “bench” positions, the axle of the wheel(s) being fixed under the tip region of the V, the wheels being mounted internally or externally to the second folds of the central framework A.

In the “shopping cart” or “handcart” position, the cart according to the invention is capable of receiving a shopping bag introduced from above into the space between the central framework A and the first end framework B, device being advantageously provided on the upper region of the shopping bag for its attachment, in this position, to the second end framework C.

The arms of the second end framework C and/or, when present, the connection between them, can carry, externally in the “shopping cart” position, removable device complementary to device carried by an accessory capable of hooking against the second end framework (C) in the “shopping cart” position. The accessory may then consist of a baby seat, a complementary carrier device such as a shopping bag, a toy bag, a parasol or a cooler, carried by a structure carrying the device for hooking on the second end framework (C).

To better illustrate the subject matter of the present invention, several particular embodiments are described below, by way of illustration and without limitation, with reference to the appended drawing.

On this drawing:

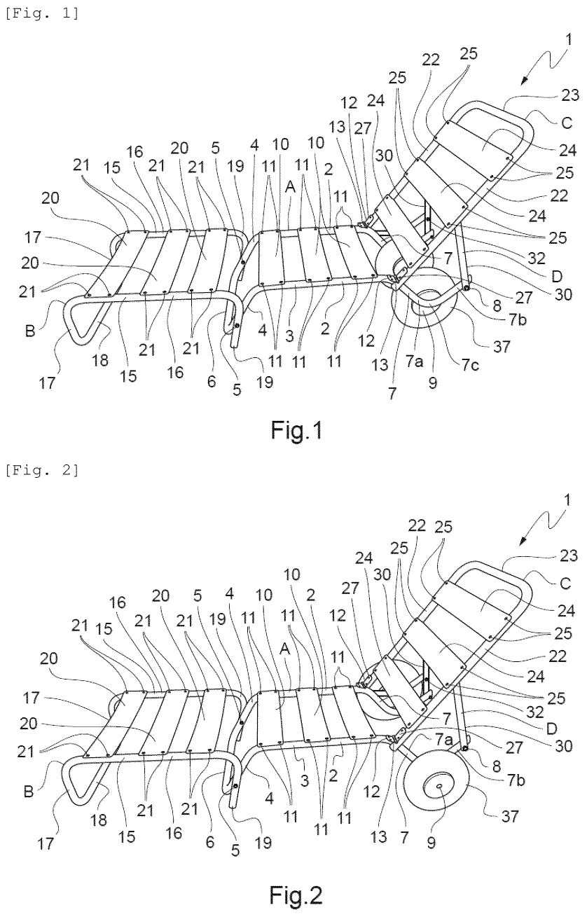

FIG. 1 is a perspective view of a shopping cart according to the present invention in its “deck chair” position;

FIG. 2 is a view similar to FIG. 1, with the wheels of the cart according to the invention positioned on the outside of the cart;

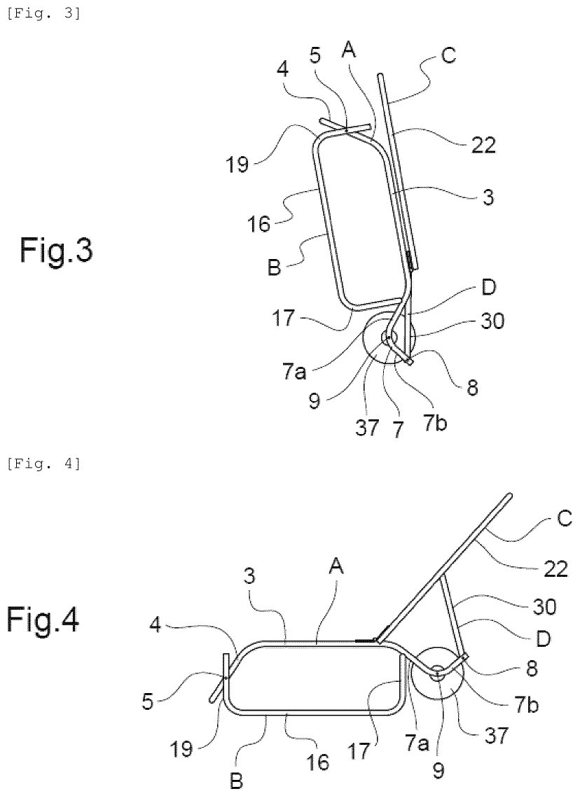

FIG. 3 is a side view of the cart shown in FIG. 1 in its “shopping cart” position;

FIG. 4 is a side view of the cart shown in FIG. 1 in its “seat” position;

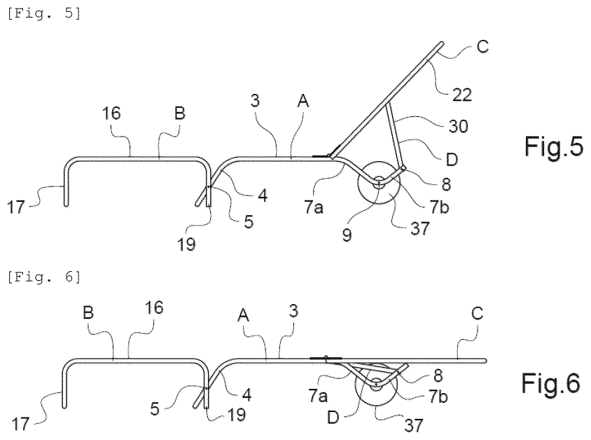

FIG. 5 is a side view of the cart shown in FIG. 1 in its “deck chair” position;

FIG. 6 is a side view of the cart shown in FIG. 1 in its “bench” position;

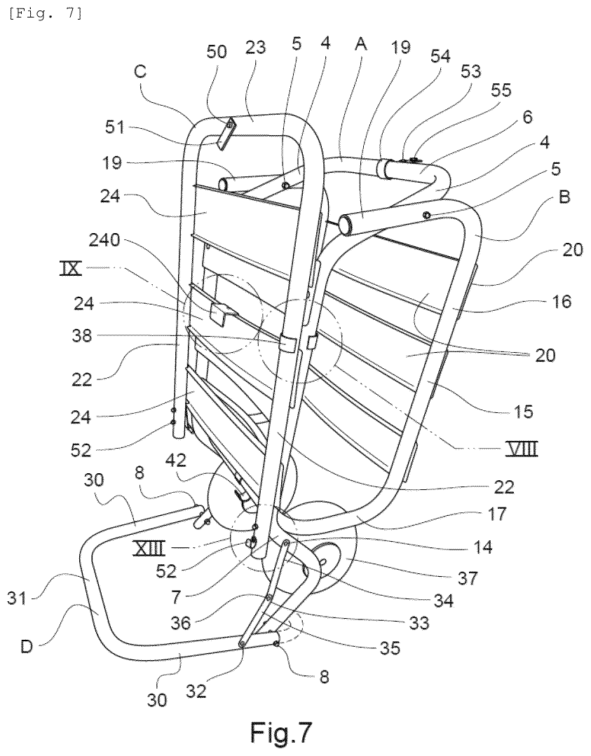

FIG. 7 is a perspective view of the cart in its “handcart” position, a variant of embodiment of the support part being shown in dash and dot lines in this figure;

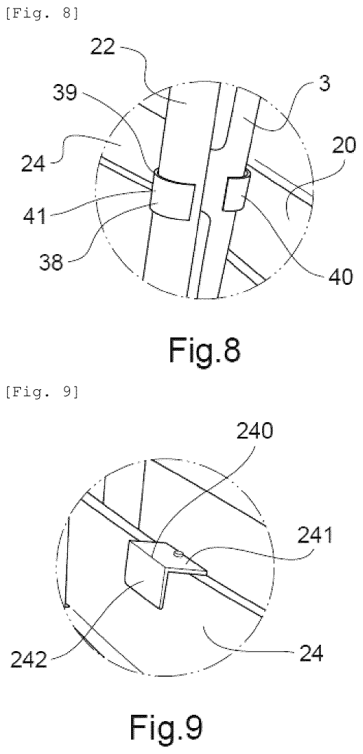

FIG. 8 is a detail view of detail VIII in FIG. 7 ;

FIG. 9 is a detail view of detail IX in FIG. 7 ;

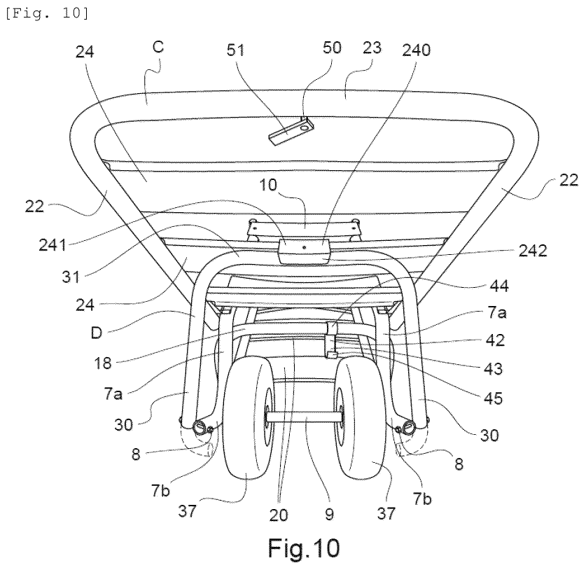

FIG. 10 is a view of the cart in its “seat” position, showing the back of the seat backrest, the variant of embodiment of the support part shown in FIG. 7 also appearing in dash and dot lines in this figure;

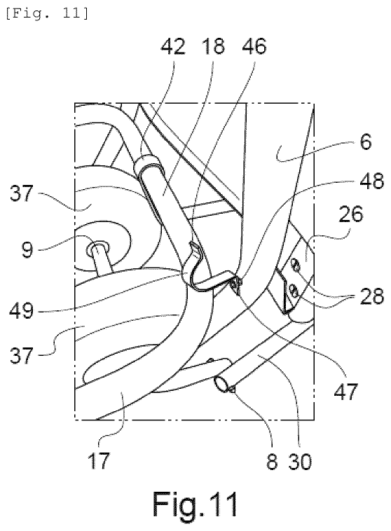

FIG. 11 is a larger scale view of a hook securing the central framework to the first end framework in its unlocked position;

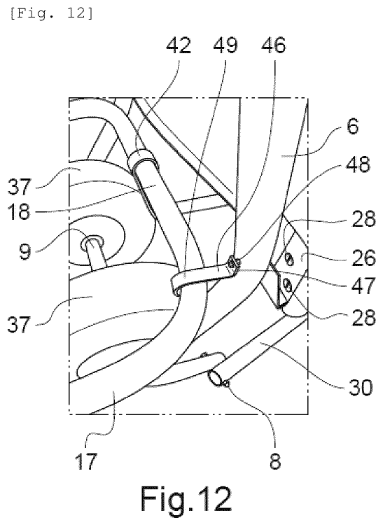

FIG. 12 is a view similar to FIG. 11, with the blocking hook in its blocking position; and

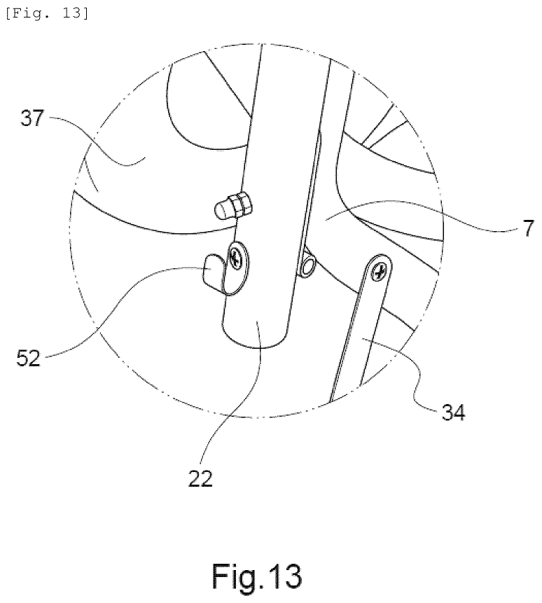

FIG. 13 is a detail view of detail XIII in FIG. 7.

FIG. 1 shows the shopping cart 1 according to one embodiment of the present invention in its “deck chair” position.

The cart 1 is made up of a framework in four parts, namely:
a central framework A;
a first end framework B;
a second end framework C; and
a support part D.

The central framework A is formed by two lateral arms 2 that each comprise a central part 3, which is parallel to the ground when the cart 1 is in the “deck chair” position shown in FIG. 1.

The central part 3 of each lateral arm 2 is extended at a first end by a first fold 4, folded at an angle of 135° in the example shown.

Each of the first folds 4 has at its centre a pin 5 perpendicular to the central part 3, the role of which will be indicated below.

The first folds 4 of each lateral arm 2 are in turn folded at their end at an angle of 90° to form a joining crosspiece 5 that connects the first two folds 4.

At their second end, the central part 3 of each lateral arm 2 is extended by a second fold 7 which comprises a first branch 7a folded at an angle of 135° relative to the central part 3 and said first branch 7a also being folded at an angle of 90° to form a second branch 7b. At their free end, each second branch 7b carries a pin 8, the role of which will be indicated below.

The branches 7a and 7b form a V flared upwards when the cart 1 is in the “deck chair” position. The tip 7c of the flared V carries an axle 9, the role of which will be indicated below.

The central parts 3 of each lateral arm 2 are joined together on their outside when the cart 1 is in the “deck chair” position by three strips of material 10, each strip being fixed to the central part 3 of the corresponding lateral arm 2 by two screws 11 placed in the corners of the strip of material 10. These strips of material 10 can be made of aluminium, plastic or fabric.

The strips 10 could also be fixed by any appropriate means, such as rivets, welding or gluing.

At the point of inflection between the central part 3 and the first branch 7a of the second fold 7, each lateral arm 2 externally carries, on its upper side, a plate 12 carrying knuckles 13 and fixed by screws, the role of which will be indicated below.

The plate 12 could also be fixed by any appropriate means, such as rivets, welding or gluing.

One of the lateral arms 2 carries, at the first branch 7a of the second fold 7, a pin 14 perpendicular to the central part 3 of the corresponding arm 2, the role of which will be indicated below.

The first end framework B is formed by two lateral arms 15 that each comprise a central part 16, which is parallel to the ground when the cart 1 is in the “deck chair” position shown in FIG. 1.

The central part 16 of each lateral arm 15 is extended at a first end by a first fold 17, folded at an angle of 90° in the example shown.

The first folds 17 of each lateral arm 15 are in turn folded at their end at an angle of 90° to form a joining crosspiece 18 that connects the first two folds 17.

At their second end, the central part 16 of each lateral arm 15 is extended by a second fold 19 folded at 90° on the same side as the first folds 17.

The central parts 16 of each lateral arm 15 are joined together on their outside when the cart 1 is in the “deck chair” position by three strips of material 20, each strip being fixed to the central part 16 of the corresponding lateral arm 15 by two screws 21 placed in the corners of the strip of material 20. These strips of material 20 may be made of aluminium, plastic or fabric.

The strips 20 could also be fixed by any appropriate means, such as rivets, welding or gluing.

The second folds 19 of the first end framework B and the first folds 4 of the central framework A are connected to each other via the corresponding pin 5 which passes through the centre of the corresponding second fold 19 of the first end framework B. By doing so, the central framework A and the first end framework B can rotate relative to each other so that the cart 1 can adopt its different positions.

The second end framework C is formed by two identical parallel lateral arms 22 folded at one end at an angle of 90° to form a joining crosspiece 23.

When the cart 1 is in the “deck chair” position, the lateral arms 22 are joined together on their outside by three strips of material 24, each strip being fixed to the

corresponding lateral arm 22 by two screws 25 placed in the corners of the strip of material 24. These strips of material 24 may be made of aluminium, plastic or fabric.

The strips 24 could also be fixed by any appropriate means, such as rivets, welding or gluing.

The central strip of material 24 carries an angle bracket 240 at its rear, the first flange 241 of which is fixed to one of the edges of the strip of material 24 and the second flange 242 of which faces downwards when the cart is in its “deck chair” position. The role of the angle bracket 240 will be indicated below.

At their end opposite the end carrying the joining crosspiece 23, each lateral arm 22 externally carries a plate 26 carrying knuckles 27 and fixed by screws 28.

The knuckles 27 carried by the second end framework C are

placed in correspondence with the knuckles 13 carried by the central framework A. A pin 29 (not shown) is placed in the knuckles 27 and 13.

In this way, two hinges are formed between the central framework A and the second end framework C at the corresponding lateral arms, enabling the second end framework C to pivot relative to the central framework so that the cart 1 of the invention can adopt its various positions.

The support part D comprises two lateral arms 30 joined at one end by a joining crosspiece 31.

One of the lateral arms 30 carries a pin 32, the function of which will be indicated below.

In an embodiment not shown, the lateral arms of the support part can be connected by strips of material.

The support part D is connected to the central framework A through each pin 8 passing through the corresponding lateral arm 30 in the vicinity of their free ends. By doing so, the support part D is able to move in rotation relative to the central framework A.

The support part D and the central framework A are also connected by an articulation 33. The articulation 33 comprises two arms 34 and 35 connected together at one of their respective ends by a pin 36.

The arm 34 is connected to the central framework A through the pin 14 which passes through the free end of the arm 34.

The arm 35 is connected to the support part D through the pin 32, which passes through the free end of arm 35.

The role of the articulation 33 is described below.

The cart 1 also has two wheels 37 which are carried internally by the axle 9 of the central framework A.

As shown in FIG. 2, the wheels 37′ can also be carried externally by the axle 9 of the central framework A.

Reference is now made to FIGS. 7 and 8. In order to block the central framework A and the second end framework C, the cart has a blocking device 38. The blocking device 38 comprises a central plate 39 bent at each of its ends by a first hook part 40 and a second hook part 41. The radius of curvature of the first hook part 40 and the second hook part 41 corresponds to the radius of the tubes which form the lateral parts of the central framework and the second end framework with which the hook parts 41 and 42 engage. The blocking device 38 may be made of aluminium or plastic.

Similarly, in order to block the first end framework B and the support part D, the cart has a blocking device 42. The blocking device 42 comprises a central plate 43 bent at each of its ends by a first hook part 44 and a second hook part 45. The radius of curvature of the first hook part 44 and the second hook part 45 corresponds to the diameter of the tubes which form the joining crosspiece 18 and the joining crosspiece 31 with which the hook parts 44 and 45 engage. The blocking device 42 may be made of aluminium or plastic.

Reference is now made to FIGS. 11 and 12. In order to block the central framework A and the first end framework B, the cart has a blocking device 46. The blocking device 46 comprises a base plate 47 with a pin 48 passing through it, which is fixed under the second fold 7 at the point of inflection between the lateral arm 3 and the first branch 7a. The blocking device 46 may be made of aluminium or plastic.

At one of its ends, the plate 47 is extended by a hook part 49, the radius of curvature of which corresponds to the diameter of the tube of the joining crosspiece 18.

To move from its unlocked position shown in FIG. 11 to its locked position shown in FIG. 12, the blocking device is pivoted about the pin 48 so that the hook part 49 engages with the joining crosspiece 18 of the first end framework B.

Reference is now made to FIG. 7. In this figure, the joining crosspiece 23 externally carries a pin 50, a plate 51 being fixed to the free end of the pin 50 and being able to rotate around it.

In the vicinity of their end, the lateral arms 22 carry hooks 52 that open upwards in the “shopping cart” position. Together, the plate 51 and the hooks 52 are able to receive an accessory such as a baby seat (not shown). The baby seat then has rods which are received in the hooks 52 and a handle part which is blocked in position by the plate 51, the latter then being perpendicular to the direction of the joining crosspiece 23, the handle then being received between the plate 51 and the joining crosspiece 23.

The cart also carries a hooking device 53 for hooking to a bicycle. The hooking device 53 is carried by the joining crosspiece 6 of the central framework A. The hooking device 53 comprises a loop 54 which surrounds the joining crosspiece 6 and is able to rotate around it. The loop is extended by a rod 55 at the end of which a bicycle can be attached by conventional device.

As shown in dash and dot lines in FIGS. 7 and 10, another embodiment of the support part D is shown, in which the corresponding edge 30 of the support part D is extended beyond the articulation pin 8 by an arm folded inwards, so that, when placed in the “handcart” position, said folded arm abuts against the corresponding lateral arm 2 of the central framework A.

The passage of the cart according to the present invention in its various positions will now be described.

When it is in its deck chair position, the cart 1 rests on the wheels 37 and on the joining crosspiece 6 of the central framework A, the joining crosspiece 18 and the free end of the second folds 19 of the first end framework B, which are in contact with the ground.

In order to form the backrest part, the second end framework C is folded relative to the central framework A and the support part D is folded so that the joining crosspiece 31 comes into contact against the rear part of the central strip of material 24 of the second end framework C and is blocked by the angle bracket 240, the strip of material 24 and the flanges 241 and 242 of the angle bracket 240 forming a space for receiving the joining crosspiece 31. By doing so, the second end framework C is blocked in its position enabling it to form the backrest of the deck chair.

In another embodiment not shown, the angle bracket 240 can be replaced by a rack allowing several adjustment options.

The central framework A acts as a seat and the first end framework B acts as a leg rest so that the user can sit with the legs extended.

Referring to FIG. 6, the cart 1 is in its “bench” position. To move from the “deck chair” position to the “bench” position, the support part D is folded down against the central framework A. The second end framework C is then folded down so that it comes into line with the central framework A and the first end framework B, so that the three frameworks A, B and C form a bench on which one person can lie down or on which several people can sit at the same time. In this configuration, the second end framework C then on each side rests on the free end of each arm 2 of the central framework A.

Referring to FIG. 4, the cart 1 is in its “seat” position. To move from the “deck chair” position to the “seat” position, the first end framework B is folded down so that it rests against the central framework A. In this “seat” position, the cart 1 rests on the wheels 37 and on the outer edges of the central parts 16 of the lateral arms 15 of the first end framework B.

Referring to FIG. 3, the cart 1 is in its “shopping cart” position. To move from the “seat” position to the “shopping cart” position, the second end framework C is folded down against the central framework A. The support part D is folded down against the central framework.

The cart is then raised so that the lateral arms of the frameworks are substantially vertical. The cart 1 can then be rolled on the wheels 37, using the joining crosspiece 23 of the second end framework C as a handle.

In this position, the space delimited by the central parts 3 and the first folds 4 of the lateral arms 2 of the central framework A and by the central parts 16 and the first folds 17 and second folds 19 of the lateral arms 15 of the first end framework B forms a reception space for a shopping bag which will be introduced into this space from above and which can be fixed to the joining crosspiece 23 of the second end framework C.

Referring to FIG. 7, the cart 1 is in its “handcart” position. In order to move from the “shopping cart” position to the “handcart” position, the support part D is extended to its maximum extension, with the two arms 34 and 35 of the articulation 33 substantially in line with each other.

By doing so, the support part D is able to receive an item and the joining crosspiece 23 of the second end framework C can be used as a handle to push the cart in its “handcart” position.

1. A transformable shopping cart capable of going from its strictly speaking “shopping cart” position to one of the following positions:
“handcart”;
“seat”;
“deck chair”; and
“bench”, comprising a framework mounted on at least one wheel, wherein the framework is made of four parts, namely:
a so-called central framework formed by two identical parallel lateral arms that each comprise a central part extended at a first end by a first fold and at the other end by a second fold on the same side as the first fold, the central parts of these two arms being joined by at least one strip of material;
on the side of the first folds of the central part, a so-called first end framework formed by two identical parallel lateral arms that each comprise a central part extended at a first end by a first fold and at the other end by a second fold on the same side as the first fold, the central parts of these two arms being joined by at least one strip of material; each second fold of the first end framework being mounted movable in rotation on each first fold of the central framework;
on the side of the second folds of the central framework, a so-called second end framework formed by two identical parallel lateral arms joined by at least one strip of material, mounted able to pivot by one of their ends at a point of the corresponding lateral arm of the central framework that is located in the vicinity of the start of the second fold of the central framework;
a so-called support part comprising two lateral edges each articulated to the corresponding end of the second folds of the lateral arms of the central framework, and a transverse end edge capable of blocking the second end framework in an inclined position relative to the central framework; the at least one wheel being carried by at least one lateral arm of the central framework in its second fold part, the axle of the at least one wheel being perpendicular to the lateral arms of the central framework;
the “shopping cart” position being obtained by applying the central framework and the second end framework against one another, a removable blocking device of these two frameworks being provided, and by pressing the first two folds of the first end framework against the respective second folds of the central framework; and the support part being in the fully raised position, a removable blocking device provided to maintain the first end framework in this position against the central framework and at least one removable blocking device being provided to maintain the support part in its raised position;
the “handcart” position differing from the “shopping cart” position in that the support part is folded down, a removable blocking device being provided to maintain the first end framework against the central framework;
the “seat” position differing from the “shopping cart” position in that the second end framework is inclined relative to the central framework, and in that the support part blocks the second end framework in its inclined position;
the “deck chair” position differing from the seat position in that the first end framework is placed in the extension of the central framework;
the “bench” position differing from the “deck chair” position in that the support part is in its position applied against the central framework and in that the second end framework comes in the extension of the central framework.

2. The cart according to claim 1, wherein the first two folds of the central framework are connected to form a U-shaped part.

3. The cart according to claim 2, wherein the base of the U which connects the first two folds of the central framework carries a device for hooking the cart to a means of locomotion.

4. The cart according to claim 3, wherein the means of locomotion is a bicycle.

5. The cart according to claim 1, wherein the first two folds of the first end framework are connected to form a U, which advantageously carries the removable hooking device for hooking to the support part.

6. The cart according to claim 1, wherein the two lateral arms of the second end framework are joined at their edges opposite their point of articulation to the central framework, to form a pull handle in the “shopping cart” position or a push handle in the “handcart” position.

7. The cart according to claim 1, wherein the removable hooking device for hooking the central framework to the second end framework is carried by at least one lateral arm of the central framework for hooking to the corresponding lateral arm of the second end framework.

8. The cart according to claim 1, wherein the removable hooking device for hooking the central framework to the first end framework is carried by a lateral arm of the central framework for hooking to the corresponding first fold of the first end framework.

9. The cart according to claim 1, wherein the removable hooking device for hooking the central framework to the first end framework is carried by a connection between the first folds of the first end framework.

10. The cart according to claim 1, wherein at least on one side, a connection having an articulation in its middle part is connected on the one hand to a lateral edge of the support part and on the other hand to the second fold of the corresponding lateral arm of the central framework.

11. The cart according to claim 1, wherein at least on one side, the corresponding edge of the support part is extended beyond the articulation pin by an arm folded inwards, so that, when placed in the “handcart” position, the folded arm abuts against the corresponding lateral arm of the central framework.

12. The cart according to claim 3, wherein the central framework, the first end framework, the second end framework and the support part are each made of a bent profile to form the necessary folds.

13. The cart according to claim 1, wherein the second folds of the central framework form a V flared upwards in the “seat” or “deck chair” or “bench” positions, the axle of the at least one wheel being fixed under the tip region of the V, the at least one wheel being mounted internally or externally to the second folds of the central framework.

14. The cart according to claim 1, wherein the cart is capable of receiving, in the “shopping cart” position or in the “handcart” position, a shopping bag introduced from above into the space between the central framework and the first end framework, device being provided on the upper region of the shopping bag for its attachment, in this position, to the second end framework.

15. The cart according to claim 1, wherein the arms of the second end framework carry, externally in the “shopping cart” position, removable device complementary to device carried by an accessory capable of hooking against the second end framework in the “shopping cart” position.

16. The cart according to claim 1, wherein a connection between the arms of the second end framework carry, externally in the “shopping cart” position, removable device complementary to device carried by an accessory capable of hooking against the second end framework in the “shopping cart” position.

17. The cart according to claim 1, wherein the arms of the second end framework and a connection between the arms of the second end framework carry, externally in the “shopping cart” position, removable device complementary to device carried by an accessory capable of hooking against the second end framework in the “shopping cart” position.

18. The cart according to claim 17, wherein the accessory consists of at least one from a baby seat, a complementary carrier device, a toy bag, a parasol, or a cooler, carried by a structure carrying the device for hooking on the second end framework.
